(19) United States
(12) Patent Application Publication
(10) Pub. No.: US 2026/0364766 A1
(43) Pub. Date: Nov. 19, 2026

(54) Hand-Held Power Tool

(71) Applicant: Robert Bosch GmbH, Stuttgart (DE)

(72) Inventors: Heiko Roehm, Stuttgart (DE); Martin Kraus, Filderstadt (DE)

(21) Appl. No.: 19/679,960

(22) Filed: May 18, 2026

(30) Foreign Application Priority Data
May 19, 2025 (DE) 10 2025 119 259.6

(51) Int. Cl. B25F 5/00

(52) U.S. Cl. CPC B25F 5/001

(57) ABSTRACT

An electric hand-held power tool having a drive motor for driving a gearbox with a clutch housing and a drive spindle is disclosed. The gearbox includes a cam ring and a bearing holder. The cam ring includes an outer peripheral region and an inner peripheral region. The cam ring includes at least one support region that is configured to be substantially planar and is arranged in a support plane between the outer peripheral region and the inner peripheral region and is configured for axial support of the bearing holder.

This application claims priority under 35 U.S.C. § 119 to patent application no. DE 10 2025 119 259.6, filed on May 19, 2025 in Germany, the disclosure of which is incorporated herein by reference in its entirety.

The disclosure relates to a hand-held power tool according to the description set forth below.

### BACKGROUND

Hand-held power tools are known from the prior art. Typically, hand-held power tools comprise an electric motor that drives a multi-stage planetary gear, and a drill chuck attached to its drive spindle as a tool holder. Typically, such products have various modes of operation, such as clutch mode, drilling mode, and hammer drilling mode, with a desired mode of operation being selectable via an actuating element. To implement these various modes of operation, hand-held power tools include at least one cam ring and one bearing holder. The cam ring is usually realized as a metal cast part with a large axial extension to allow for high bending strength.

### SUMMARY

The disclosure is based on the object of providing a hand-held power tool that is improved in terms of compactness, in particular shortened in terms of axial overall length.

This object is achieved with the features set forth below. Suitable further developments are also set forth below.

The hand-held power tool according to the disclosure comprises a drive motor for driving a gearbox having a clutch housing and a drive spindle. The gearbox has a cam ring and a bearing holder, the cam ring having an outer peripheral region and an inner peripheral region. In order to achieve a particularly compact axial design of the hand-held power tool, the cam ring comprises at least one support region that is substantially planar, is arranged in a support plane between the outer peripheral region and the inner peripheral region, and is configured to axially support the bearing holder.

The at least one support region arranged in a support plane is substantially planar, i.e., substantially free of protrusions and/or depressions. In particular, the at least one support region forms a flat surface. The cam ring preferably comprises a plurality of support regions. The support regions form a support plane. The support regions or the support plane are designed for axially supporting the bearing holder. The support plane is substantially planar, i.e., free of protrusions and/or depressions. A reduction in the axial overall length of the hand-held power tool is enabled, in particular, by reducing the wall thickness of the support plane.

A structurally particularly advantageous configuration provides that at least one spacer element is arranged on the cam ring, wherein the gearbox comprises a clutch pressure plate with at least one recess, wherein the at least one spacer element is engageable with the at least one recess. The at least one spacer element faces the gearbox in the axial direction, in particular the clutch pressure plate. The at least one spacer element faces away from the tool holder in the axial direction. Preferably, the cam ring comprises a plurality of spacer elements. For example, the cam ring has two or more spacer elements. For example, the cam ring has three or ten spacer elements. Preferably, a plurality of spacer elements are provided at even angular distances. In particular, the cam ring has three spacer elements. The at least one spacer element or the plurality of spacer elements is or are preferably integrally formed with the cam ring.

According to a structurally advantageous embodiment for achieving a reduction in the axial overall length, the at least one spacer element is preferably arranged on the inner peripheral region.

In order to additionally enable radial support of the bearing holder on the cam ring in addition to axial support, in a structurally advantageous further embodiment, at least one limiting element arranged on the outer peripheral region of the cam ring, preferably configured in a collar shape, is provided.

A structurally advantageous further development provides that at least one further limiting element is arranged on the inner peripheral region of the cam ring substantially concentrically to the at least one limiting element, wherein the at least one spacer element is arranged on the at least one further limiting element.

In order to enable a reduction in weight and a saving of material while providing stable axial support of the bearing holder on the cam ring or on its support region(s), or to enable assembly (analogously to a bayonet lock), the cam ring may comprise at least one, preferably a plurality, of recesses. The recesses are preferably formed at uniform, in particular substantially uniform, angular distances or angular ranges. The recesses can be arranged at uniform distances, in particular relative to one another. An irregular arrangement of the recesses is also conceivable, in particular at irregular angular distances. An angular distance or angular range can be understood as a range that is formed between adjacent recesses and includes a corresponding angle. The recesses each separate adjacent support regions at least in sections. The recesses each separate adjacent support regions at least in sections. The cam ring is substantially annular or circular. Angular distances or angular ranges may be specified in ranges between 0 and 360°. Preferred angular distances or angular ranges are between 15° and 345°, further preferred angular distances or angular ranges are between 30° and 330°, further preferred angular distances or angular ranges are between 45° and 315°, further preferred angular distances or angular ranges are between 60° and 300°, further preferred angular distances or angular ranges are between 75° and 285°, further preferred angular distances or angular ranges are between 90° and 270°, further preferred angular distances or angular ranges are between 105° and 255°, further preferred angular distances or angular ranges are between 120° and 240°. Particularly preferred angles are between 75° and 135°. Moreover, preferred angular distances or angular ranges are between 90° and 120°. In the above-mentioned information or ranges, the respective limits are always included. The at least one support region can also have an angular distance or an angular range.

In a further, structurally advantageous configuration, the clutch pressure plate comprises a collar that extends axially toward the drive motor and/or transmission and at least partially surrounds the clutch housing or gearbox housing.

A structurally particularly advantageous configuration for reducing the axial overall length provides that the bearing holder comprises a substantially annular base body, wherein at least one support element, in particular angled relative to the base body, is arranged on the base body, wherein the at least one support element is arranged transversely to the at least one support region.

In an advantageous further development, it can also be provided that the base body has at least one transfer element on which the at least one support element is arranged. This allows, in a structurally simplified manner, the realization of a stable bearing holder for stable axial support of the bearing holder and a reduction in axial overall length.

In order to meet high mechanical requirements and to be able to provide a correspondingly stable cam ring, it can be provided that the cam ring is at least partially made of a metallic material. Preferably, the cam ring is at least predominantly, in particular entirely, made of a metallic material.

Alternatively or additionally, it is intended to provide a correspondingly stable bearing holder that is at least partially made of a metallic material. Preferably, the bearing holder is at least predominantly, in particular entirely, made of a metallic material.

In order to achieve a particularly compact axial design of the hand-held power tool, the bearing holder comprises at least one support element which can be arranged transversely to the cam ring on the at least one support region.

The support element can be arranged transversely to the cam ring on the at least one support region, in particular by way of a support surface configured on the support element. The support element is arranged transversely to the cam ring on the at least one support region. The support surface of the support element is arranged transversely to the cam ring on the at least one support region. The support element can, in particular, be arranged or is arranged perpendicular to the cam ring on the at least one support region. In particular, an angle greater than 0 is included between the support element and the support region. Suitable angular ranges between the support element and the cam ring or the support region may be between 1° and 90°. Accordingly, an arrangement transverse to the cam ring in particular does not mean a parallel arrangement in which an included angle between the support element and the cam ring or support region is 0°.

A structurally particularly advantageous further development provides that the bearing holder comprises a base body, wherein the base body comprises at least one transfer element on which the at least one support element is arranged.

In order to realize a stable bearing holder in a structurally simplified manner, the transfer element and the at least one support element are integrally formed.

A particularly advantageous further development provides that the at least one support element is arranged at an angle to the at least one transfer element and/or that the at least one transfer element is arranged at an angle to the base body. Advantageously, a reduction in the axial overall length can also be achieved.

In order to enable radial support or radial limitation in addition to axial support of the bearing holder, the at least one support element comprises a section that forms a radial support surface.

With the embodiment according to the disclosure, a reduction in the axial overall length of the hand-held power tool can be realized in a structurally simplified manner. In particular, a reduction in length can be achieved by reducing the axial dimension or extension of the support plane of the cam ring. The cam ring can be realized with reduced material usage, resulting in corresponding cost savings. A reduction in the axial design length can also be achieved by the clutch pressure plate, which can be realized with a correspondingly shortened axial extension. Also advantageous is a reduction in vibration during clutch operation due to a reduction in weight of the clutch pressure plate.

### BRIEF DESCRIPTION OF THE DRAWINGS

Further advantages and expedient embodiments can be found in the claims, description of the figure and the drawings. It shows:

FIG. 1 a highly simplified schematic illustration of a hand-held power tool

FIG. 2 an excerpt of the hand-held power tool in a sectional view with a cam ring of a first embodiment,

FIG. 3 a front view of a cam ring of a first embodiment,

FIG. 4 the cam ring according to FIG. 3 in a rear view,

FIG. 5 a representation of the cam ring in a clutch position,

FIG. 6 a representation of the cam ring in a drilling position,

FIG. 7 a representation of the cam ring in an impact drilling position,

FIG. 8 an excerpt of the hand-held power tool in a sectional view with a cam ring of a second embodiment,

FIG. 9 a front view of a cam ring of a second embodiment,

FIG. 10 the cam ring according to FIG. 9 in a rear view,

FIG. 11 an illustration of a clutch pressure plate in a front view,

FIG. 12 the clutch pressure plate in a rear view,

FIG. 13 a front view of a bearing holder,

FIG. 14 the bearing holder according to FIG. 13 in a rear view,

FIG. 15 an illustration of a clutch pressure plate in a further embodiment.

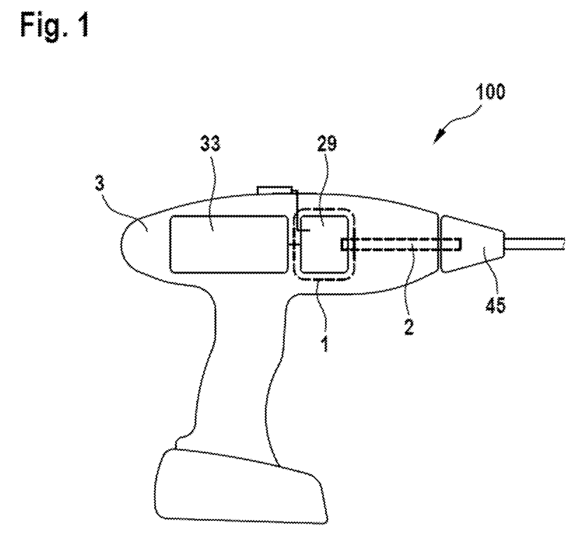

### DETAILED DESCRIPTION

In the figures, identical elements are marked with identical reference numbers.

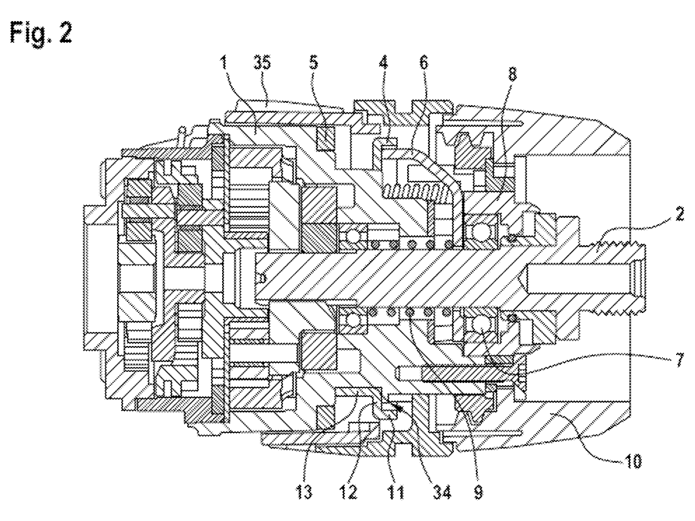

For example, the hand-held power tool 100 shown in the figures is embodied as an impact drilling machine and has a drive motor 33 shown schematically in a housing 3, which drives a drive spindle 2 via a gearbox 29 arranged in a clutch housing 1, which is preferably embodied as a planetary gear, and which carries a drill chuck 45 with a tool holder (not shown). A ball bearing 7 is fixedly connected to the drive spindle 2 (see FIG. 2).

More particularly, the hand-held power tool 100 is an electric hand-held power tool 100 that preferably includes at least one battery, and the at least one battery is preferably interchangeable.

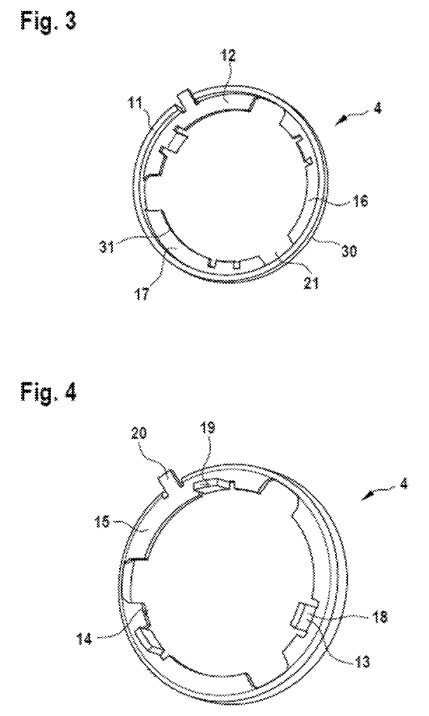

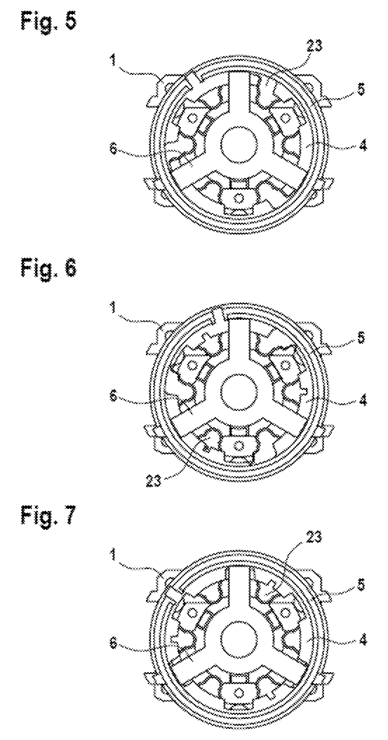

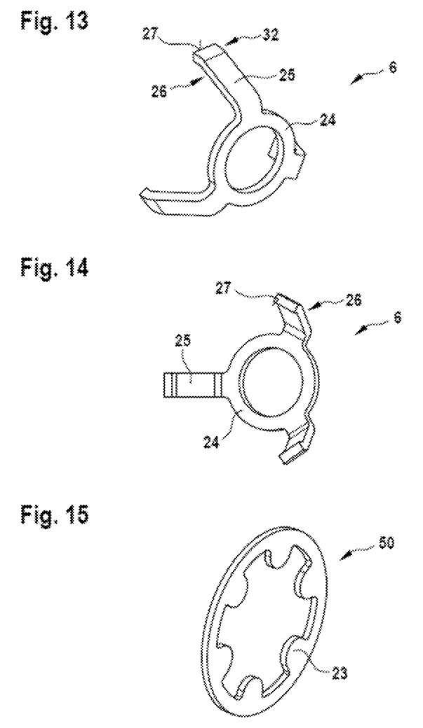

The gearbox comprises a cam ring 4 of a first embodiment (see also FIGS. 3 and 4) and a bearing holder 6 (see also FIGS. 13 and 14). The cam ring 4 has an outer peripheral region 30 and an inner peripheral region 31.

The cam ring 4 has planar or flat support regions 17, which are arranged in a support plane 12 between the outer peripheral region and the inner peripheral region and are configured to axially support the bearing holder 6. The support regions 17 form a support plane 12.

The cam ring 4 is annular and has a front side 16 and a rear side 15. The support regions 17 are arranged on the front side 16. The support plane 12 is configured on the front side 16.

The cam ring 4 according to the first embodiment comprises a limiting element 11 on the front side 16. The limiting element 11 is configured as an outer collar. The limiting element 11 is configured as an annular outer collar. The limiting element 11 is integrally formed with the cam ring 4. In addition to axial support of the bearing holder 6, the limiting element 11 allows radial support or radial limitation of the bearing holder 6. The limiting element 11 is adapted to radially support the bearing holder 6, in particular under load.

The outer collar, or the limiting element 11, comprises an interruption, in the region of which an optional rotational drive 20 for carrying out a rotational movement of the cam ring 4 is arranged. The rotational entrainment 20 couples the cam ring 4 to a control element, for example a separate mode selector 35 or an adjustment ring 10.

The outer collar or the limiting element 11 has a radial wall thickness that is smaller than an axial length or extension of the outer collar or the limiting element 11.

The limiting element can be formed continuously on the cam ring in a manner not shown in more detail, i.e., without interruption. The limiting element itself may be configured only optionally in a manner not shown.

The curve ring 4 of the first embodiment shown in FIGS. 2 and 3 has a Z-shape in cross-section, i.e., it is Z-shaped in cross-section. The cam ring 4 comprises three spacer elements 18, each of which can be supported or are supported for axial support of the cam ring 4 on the clutch housing 1 or, in a drilling position, on a clutch pressure plate 5 (see also FIGS. 5 - 7). For this purpose, the spacer elements 18 each comprise a support surface 19, which serves to transfer an axial force from the drill chuck in the drill position and/or clutch position.

The rear side 15 of the cam ring 4 is axially offset from the support surfaces 19 to allow the clutch pressure plate 5 to move axially during clutch operation.

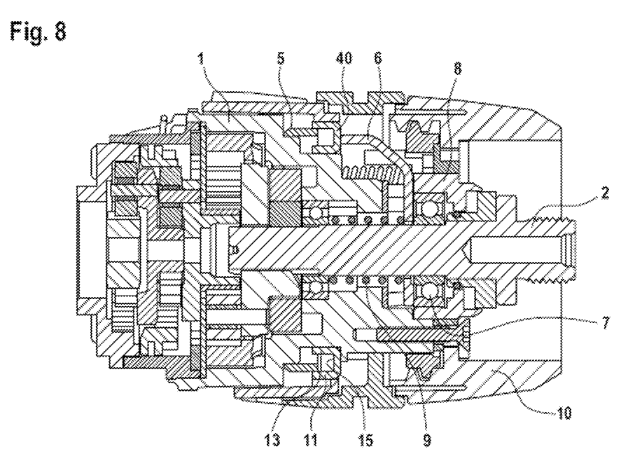

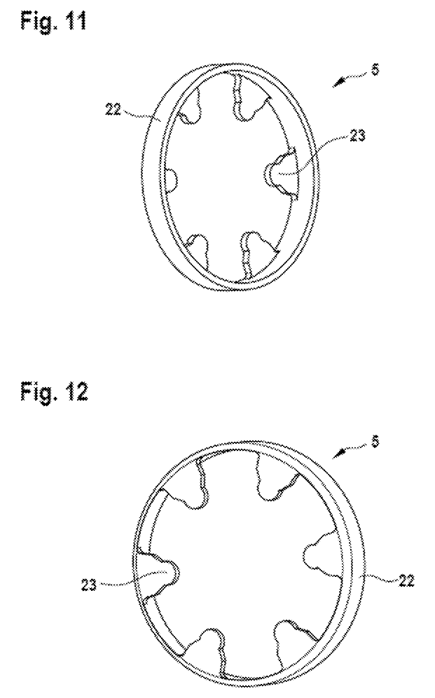

The clutch pressure plate 5 (see FIGS. 8, 11 and 12) comprises an annular collar 22 (outer collar) and a plurality of pressure sheet-metal tabs 23 arranged axially between the latching bodies and compression springs. A radial wall thickness of the collar 22 is less than an axial extension (length) of the collar 22. A radial wall thickness of the collar 22 is similar to or equal to an axial wall thickness of the pressure sheet-metal tabs 23. Typical wall thicknesses range from 0.5 mm to 2.0 mm. The clutch pressure plate 50 shown in FIG. 15 is flat or planar and does not have an outer collar (see also FIG. 2).

The cam ring 4 further has a radial guide surface 14, which centers the cam ring 4 on the clutch housing 1 and allows for rotational movement of the cam ring 4 relative to the clutch housing 1.

The support region 17 serves to axially support the bearing holder 6 on the cam ring 4 in the drill position and in the clutch position. When the bearing holder 6 is supported on the support region 17, the ball bearing 7 of the drive spindle 2 is positioned axially in the clutch housing 1 and thus forms a fixed bearing.

The support regions 17 or the support plane 12 respectively comprise recesses 21. In the exemplary embodiment shown, three recesses 21 are formed. The recesses 21 are evenly arranged on or in the curve ring 4. The three recesses 21 are arranged at regular intervals, in particular at angular distances or in angular ranges, on or in the curve ring 4. The recesses 21 separate adjacent support regions 17.

The bearing holder 6 comprises a base body 24 on which three transfer elements 25 and three support elements 26 are arranged. The transfer elements 25 are respectively arranged between the base body 24 and the respective support elements 26. The transfer elements 25 are arranged at an angle to the base body 24. The transfer elements 25 are arranged at an angle to the respective support element 26 arranged thereon. Advantageous angular ranges between the base body 24 and the transfer element 25 may be between 95° and 170°. Advantageous angular ranges between the transfer element 25 and support element 26 may be between 100° and 170°.

The bearing holder 6 is designed integrally, i.e. base body 24, transfer elements 25, and support elements 26 are integrally designed.

The bearing holder 6 has a bell shape and is correspondingly bell-shaped.

In a manner not shown in greater detail, the transfer elements can also extend perpendicularly from the base body.

The base body 24 of the bearing holder 6 is annular. The base body 24 forms a support surface for the ball bearing 7.

The transfer elements 25 are configured as elongated (axial) extensions that widen radially.

The transfer elements 25, and in particular the support elements 26, terminate in axially aligned support surfaces 27 for axial support of the bearing holder 6 on the cam ring 4 and/or its support regions 17. The support elements 26 are each equipped with support surfaces 27 for axial support of the bearing holder 6.

The support elements 26 optionally each comprise a radial support region 32 for, in particular, additional radial support of the bearing holder 6, in particular on the limiting element 11. The radial support regions 32 have a gap to an inner surface of the limiting element 11 in an unloaded state. The gap may have a width of 0.1 mm to 3.0 mm, preferably from 0.3 mm to 1.5 mm, more preferably from 0.5 mm to 0.8 mm. In the event of an increased axial load in the clutch or drilling position, the radial support regions 32 are moved in the radial direction until they contact the limiting element 11. Thus, it is not necessary for the bearing holder 6 to have sufficient strength to prevent deformation, but rather it can be limited accordingly by the limiting element 11. The radial support regions 32 are set up axially parallel, i.e., parallel to an axis that extends in the axial direction, and may be understood and referred to as axially parallel sections.

Alternatively, the support regions may only be aligned axially parallel under load upon contacting the limiting element 11.

In a manner not shown in greater detail, the radial support region can be cylindrical in shape so that an extensive radial support can be made possible under load.

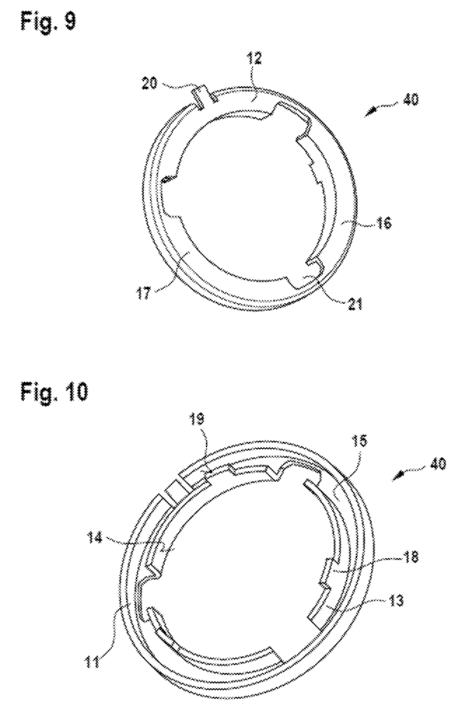

The curve ring 40 of the second embodiment shown in FIGS. 9 and 10 has a C-shape in cross-section, i.e., it is C-shaped in cross-section (also see FIG. 8). The rear side 15 of the cam ring 40 is axially offset from the support surfaces 19 to allow the clutch pressure plate 5 to move axially during clutch operation.

The cam ring 40 according to the second embodiment does not comprise a limiting element on the front side 16. However, the cam ring 40 comprises a limiting element 11 on the rear side 15. The limiting element 11 is configured as an outer collar. The limiting element 11 is configured as an annular outer collar. The limiting element 11 is integrally formed with the cam ring 40.

The cam ring 40 has a further limiting element 13 on the inner peripheral region on the rear side 15, which is arranged substantially concentrically with the limiting element 11. Spacer elements 18 are arranged on the further limiting element 13 and can be supported on the clutch housing 1 and the clutch pressure plate 5, respectively, for axial support of the cam ring 40.

The hand-held power tool 100 has three modes of operation, namely clutch operation, drilling operation, and impact drilling operation (see FIGS. 5 - 7). The modes of operation are selectable via the mode selector 35. When the cam ring 4 is positioned such that the support elements 26 or the support surfaces 27 of the bearing holder 6 align with the recesses 21, axial movement of the bearing holder 6 is enabled in impact drilling operation.

An axial support surface of the cam ring 4 or 40 on the clutch housing 1 is provided on the front side 16 of the cam ring 4, which ensures locking of the torque coupling in the drilling position and the impact drilling position.

The axial support of the cam ring 4, 40 on the clutch housing 1 (see support position 34 in FIGS. 2 and 8) is carried out, in particular in the direction of the drill chuck 15, in the same plane as the support of the bearing holder 6 on the cam ring 4, 40. The support is carried out substantially perpendicular to a longitudinal extension of the support element. An axial support region of the bearing holder lies, preferably substantially, perpendicular to the axial extension of the support element.

A coupling strength is adjustable via the adjustment ring 10. The adjustment ring 10 locks directly or indirectly onto the clutch housing 1 in the clutch positions, drill position, and impact drilling position.

By different rotational orientations or positions of the cam ring, for example by two or three rotationally different orientations or positions of the cam ring, clutch and drilling operation or clutch, drilling, and impact drilling operation are enabled on the clutch housing. Changing an operating mode includes a rotational movement (twisting) of the cam ring.

The clutch pressure plate 5, 50 is part of an adjustable torque clutch, wherein a spring bias of the clutch pressure plate 5, 50 can be changed by rotating the adjustment ring 10.

The bearing holder 6 limits axial movement of the ball bearings in the drill position and in clutch operation. When the cam ring 4, 40 is in the impact drilling position, the cam ring 4, 40 releases axial movement of the bearing holder 6, whereby a locking mechanism 8 can be brought into engagement under axial load. When the bearing holder 6 is not released, the axial forces are transmitted from the drill chuck into the clutch housing 1 via the bearing holder 6 and the cam ring 4 or via the clutch pressure plate 5, 50 into the clutch housing 1. A spring 9 guides the bearing holder 6 back into a position remote from the gearbox in the impact drilling position, so that the cam ring can be adjusted again and, without contact pressure on a workpiece, the locking mechanism 8 is disengaged.

The cam ring is preferably fabricated by a punching-bending process. Preferably, the cam ring has a substantially uniform wall thickness, in particular with regard to its respective components, in particular spacer elements, outer collars, etc. (see FIGS. 3, 4, 9 and 10). The bearing holder is preferably fabricated by a punching-bending process. Preferably, the bearing holder has a substantially uniform wall thickness, in particular with regard to its respective components or constituent parts (see FIGS. 13 and 14).

What is claimed is:

1. An electric hand-held power tool, comprising:
a clutch housing;
a gearbox arranged in the clutch housing, the gearbox including a cam ring and a bearing holder;
a drive spindle;
a drive motor configured to drive the drive spindle via the gearbox,
wherein the cam ring comprises an outer peripheral region and an inner peripheral region, and
wherein the cam ring further comprises at least one support region that is configured to be substantially planar and is arranged in a support plane between the outer peripheral region and the inner peripheral region and is configured for axial support of the bearing holder.

2. The hand-held power tool according to claim 1, wherein:
at least one spacer element is arranged on the cam ring,
the gearbox comprises a clutch pressure plate having at least one recess, and
the at least one spacer element is brought into engagement with the at least one recess.

3. The hand-held power tool according to claim 2, wherein the at least one spacer element is arranged on the inner peripheral region.

4. The hand-held power tool according to claim 1, further comprising at least one limiting element arranged on the outer peripheral region.

5. The hand-held power tool according to claim 4, further at least one further limiting element arranged on the inner peripheral region substantially concentrically with the at least one limiting element, wherein the at least one spacer element is arranged on the at least one further limiting element.

6. The hand-held power tool according to claim 1, wherein:
the cam ring further comprises support regions, and
the cam ring further comprises recesses formed at angular intervals and each separating adjacent support regions at least in sections.

7. The hand-held power tool according to claim 2, wherein the clutch pressure plate comprises a collar facing axially toward the drive motor and at least partially encompassing the clutch housing.

8. The hand-held power tool according to claim 1, wherein:
the bearing holder comprises a substantially annular base body on which at least one support element is arranged, and
the at least one support element is arranged transversely to the at least one support region.

9. The hand-held power tool according to claim 8, wherein the base body comprises at least one transfer element on which the at least one support element is arranged.

10. The hand-held power tool according to claim 1, wherein the cam ring is at least partially made of a metallic material.

11. The hand-held power tool according to claim 4, wherein the at least one limiting element is configured in a collar shape.

12. The hand-held power tool according to claim 1, wherein:
the cam ring further comprises support regions, and
the cam ring further comprises recesses formed at uniform, angular intervals and each separating adjacent support regions at least in sections.

13. The hand-held power tool according to claim 1, wherein:
the bearing holder comprises a substantially annular base body on which at least one support element, angled relative to the base body, is arranged, and
the at least one support element is arranged transversely to the at least one support region.
